(19) United States
(12) Patent Application Publication
(10) Pub. No.: US 2013/0070716 A1
(43) Pub. Date: Mar. 21, 2013

(54) APPARATUS AND METHOD FOR TRANSMITTING POWER HEADROOM IN MULTIPLE COMPONENT CARRIER SYSTEM

(71) Applicants: Ki Bum Kwon, Seoul (KR); Myung Cheul Jung, Seoul (KR)

(72) Inventors: Ki Bum Kwon, Seoul (KR); Myung Cheul Jung, Seoul (KR)

(73) Assignee: Pantech Co., Ltd., Seoul (KR)

(21) Appl. No.: 13/699,556

(22) PCT Filed: Jun. 16, 2011
(86) PCT No.: PCT/KR11/04434

§ 371 Date: Nov. 21, 2012

(30) Foreign Application Priority Data
Jun. 18, 2010 (KR) 10-2010-0058034

(51) Int. Cl. H04W 72/04

(52) U.S. Cl. 370/329

(57) ABSTRACT

An apparatus and method provide a mobile station transmits power headroom information in a multiple component carrier system. The apparatus and method include receiving a mode decision parameter for deciding a mode of a Power Headroom Report (PHR) for UpLink Component Carriers (UL CCs), configured in a mobile station, from a base station, deciding the mode of the PHR based on the mode decision parameter, and transmitting the power headroom information to the base station based on the decided mode of the PHR. Accordingly, there are advantages in that limited radio resources can be efficiently used because a mobile station's overhead according to a PHR can be reduced and a base station can efficiently perform uplink scheduling and link adaptation.

### CROSS-REFERENCE TO RELATED APPLICATIONS

This application is the National Stage Entry of International Application No. PCT/KR2011/004434, filed on Jun. 16, 2011 and claims priority from and the benefit of Korean Patent Application No. 10-2010-0058034, filed on Jun. 18, 2010, both of which are hereby incorporated by reference for all purposes as if fully set forth herein.

### BACKGROUND

1. Field

The present invention relates to wireless communication, and more particularly, to an apparatus and method for transmitting power headroom information in a multiple component carrier system.

2. Discussion of the Background

In general, a method of a base station efficiently utilizing the resources of a mobile station is to use power information about the mobile station. Power control technology is essential and core technology for minimizing interference factors and reducing the battery consumption of a mobile station in order to efficiently distribute resources in wireless communication.

In relation to the technology, a Power Headroom Report (hereinafter referred to as a ‘PHR’) is used to inform a mobile station that the mobile station can additionally use how much power. Power headroom means a difference between power that can be transmitted by a mobile station to the highest degree and power now being transmitted by the mobile station. The reason why a mobile station performs a PHR to a base station is that the amount of wireless resources, exceeding the capability of a specific mobile station, is prevented from being allocated to the specific mobile station.

### SUMMARY

It is an object of the present invention to provide an apparatus and method for transmitting power headroom information in a multiple component carrier system.

It is another object of the present invention to provide an apparatus and method for deciding a mode in which power headroom information is transmitted in a multiple component carrier system.

It is yet another object of the present invention to provide an apparatus and method for configuring a parameter to decide a mode in which power headroom information is transmitted in a multiple component carrier system.

It is further yet another object of the present invention to provide an apparatus and method for configuring a Medium Access Control (MAC) Packet Data Unit (PDU), including a mode in which power headroom information is transmitted, in a multiple component carrier system.

It is further yet another object of the present invention to provide an apparatus and method for configuring a message for transmitting power headroom information in a multiple component carrier system.

According to an aspect of the present invention, there is provided a method of a mobile station transmitting power headroom information in a multiple component carrier system. The method includes receiving a mode decision parameter for deciding a mode of a Power Headroom Report (PHR) for UpLink Component Carriers (UL CCs), configured in a mobile station, from a base station, deciding the mode of the PHR based on the mode decision parameter, and transmitting the power headroom information to the base station based on the decided mode of the PHR.

The mode of the PHR includes a first mode in which power headroom information about all the configured UL CCs is transmitted and a second mode in which power headroom information about some of the configured UL CCs is transmitted.

According to another aspect of the present invention, there is provided an apparatus for transmitting power headroom information in a multiple component carrier system. The apparatus includes a mode decision parameter receiver for receiving a mode decision parameter for deciding a mode of a PHR for configured UL CCs from a base station, a mode decision unit for deciding the mode of the PHR as a first mode or a second mode based on the mode decision parameter, a power headroom value generator for generating power headroom values for all the configured UL CCs when the mode of the PHR is the first mode and for generating power headroom values for some of the configured UL CCs when the mode of the PHR is the second mode, a power headroom message generator for generating a power headroom message for transmitting the generated power headroom values, and a power headroom message transmitter for transmitting the generated power headroom message.

Further, according to another aspect of the present invention, there is a provided method of a mobile station performing a power headroom report. The method includes determining whether any one of a case in which path loss variations is higher than a specific threshold and a prohibit power headroom report timer expires, a case in which a periodic power headroom report timer expires, and a case in which the power headroom report is configured or re-configured by an upper layer is occurred in a case in which a mobile station has uplink resources for new transmit; and triggering the power headroom report when any one of the cases is occurred. In this aspect of the present invention, the power headroom report includes a field indicating whether there is a power headroom report for each uplink subcomponent carrier.

The wireless communication system according to the present invention can reduce overhead according to a PHR by setting a mode regarding whether power headroom pertinent to which component carrier will be reported. Furthermore, in a multiple component carrier system, a PHR procedure can be clearly performed.

That is, according to this specification, a reserved field can be used for a component carrier for power headroom transmission according to the present invention without increasing the existing LCID field. Accordingly, there are advantages in that the accuracy of power headroom transmission in each component carrier can be improved and predetermined resources can be efficiently used.

Accordingly, there is an advantage in that the efficiency of uplink scheduling and link adaptation in a base station can be improved.

### BRIEF DESCRIPTION OF THE DRAWINGS

FIG. 1 is shows a wireless communication system;

FIG. 2 is an explanatory diagram illustrating an intra-band contiguous carrier aggregation;

FIG. 3 is an explanatory diagram illustrating an intra-band non-contiguous carrier aggregation;

FIG. 4 is an explanatory diagram illustrating an inter-band carrier aggregation;

FIG. 5 shows an example of a protocol structure for supporting multiple carriers;

FIG. 6 shows an example of a frame structure for the operation of multiple carriers;

FIG. 7 shows a linkage between a DL CC and a UL CC in a multiple carrier system;

FIG. 8 is a graph shows an example of power headroom in the time-frequency axis;

FIG. 9 is a graph shows another example of power headroom to which the present invention is applied in the time-frequency axis;

FIG. 10 is a flowchart illustrating a method of a mobile station performing a PHR according to an example of the present invention;

FIG. 11 is a block diagram showing a message structure of a reference CC indicator according to an example of the present invention;

FIG. 12 is a block diagram showing a message structure of a reference CC indicator according to another example of the present invention;

FIG. 13 is a block diagram showing a message structure of a reference CC indicator according to yet another example of the present invention;

FIG. 14 is a flowchart illustrating a method of a mobile station deciding a mode according to an example of the present invention;

FIG. 15 is an explanatory diagram illustrating a mode decision method according to an example of the present invention;

FIG. 16 is an explanatory diagram illustrating a mode decision method according to another example of the present invention;

FIG. 17 is an explanatory diagram illustrating a mode decision method according to yet another example of the present invention;

FIG. 18 is a diagram showing a structure of a PH message for transmitting a power headroom value according to an example of the present invention;

FIG. 19 is a diagram showing a structure of a PH message for transmitting a power headroom value according to another example of the present invention;

FIG. 20 is a diagram showing a structure of a PH message for transmitting a power headroom value according to yet another example of the present invention; and

FIG. 21 is a block diagram showing a power headroom transmitter according to an example of the present invention.

### DETAILED DESCRIPTION OF THE ILLUSTRATED EMBODIMENTS

Hereinafter, in this specification, some embodiments of the present invention will be described in detail with reference to some exemplary drawings. It is to be noted that in assigning reference numerals to respective elements in the drawings, the same reference numerals designate the same elements although the elements are shown in different drawings. Furthermore, in describing the present invention, a detailed description of the known functions and constructions will be omitted if it is deemed to make the gist of the present invention unnecessarily vague.

Furthermore, in describing the elements of this specification, terms, such as the first, second, A, B, a, and b, may be used. However, the terms are used to only distinguish one element from the other element, but the essence, order, and sequence of the elements are not limited by the terms. Furthermore, in the case in which one element is described to be “connected”, “coupled”, or “jointed” to the other element, the one element may be directly connected or coupled to the other element, but it should be understood that a third element may be “connected”, “coupled”, or “jointed” between the two elements.

Furthermore, in this specification, a wireless communication network is chiefly described. Tasks performed in the wireless communication network may be performed in a process of a system (for example, a base station), managing the wireless communication network, control the network and transmitting data or may be performed by a mobile station coupled to the network.

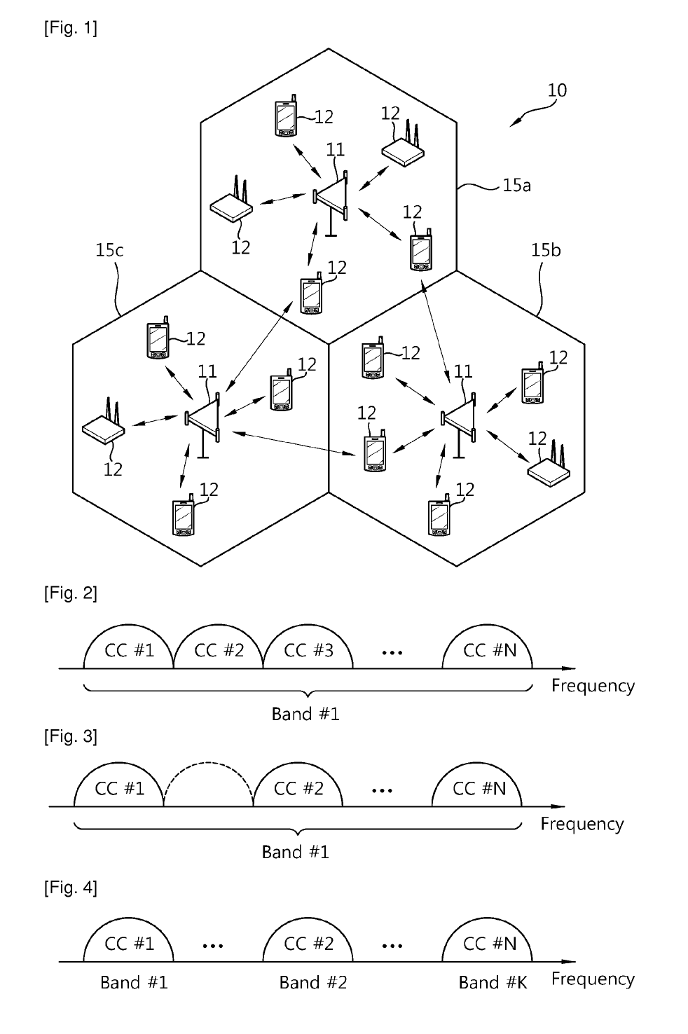

FIG. 1 is shows a wireless communication system.

Referring to FIG. 1, the wireless communication systems 10 are widely deployed in order to provide a variety of communication services, such as voice and packet data. The wireless communication system 10 includes one or more Base Stations (BS) 11. Each BS 11 provides communication services to specific geographical areas (typically called cells 15a, 15b, and 15c. The cell may be classified into a plurality of areas (called a sector).

The Mobile Stations (MS) 12 may be fixed or mobile and may also be called another terminology, such as a UE (User Equipment), an MT (Mobile Terminal), a UT (User Terminal), an SS (Subscriber Station), a wireless device, a PDA (Personal Digital Assistant), a wireless modem, or a handheld device.

The BS 11 refers to a fixed station communicating with the MS 12, and it may also be called another terminology, such as eNodeB (evolved NodeB: eNB), a BTS (Base Transceiver System), or an access point. The cell should be interpreted as a comprehensive meaning indicating some areas covered by the BS 11, and it has a meaning to comprehensively cover various coverage areas, such as a mega cell, a macro cell, a micro cell, a pico cell, and a femto cell.

Hereinafter, downlink (DL) refers to communication from the BS 11 to the MS 12, and uplink (UL) refers to communication from the MS 12 to the BS 11. In downlink, a transmitter may be a part of the BS 11, and a receiver may be a part of the MS 12. In uplink, a transmitter may be a part of the MS 12, and a receiver may be a part of the BS 11.

There are no limits to multiple access schemes applied to the wireless communication system. A variety of multiple access schemes, such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA, may be used.

In UL transmission and DL transmission, a TDD (Time Division Duplex) scheme in which the transmission is performed using different points of time may be used, or an FDD (Frequency Division Duplex) scheme in which the transmission is performed using different frequencies may be used.

A carrier aggregation (CA) supports a plurality of carriers. The carrier aggregation is also called a spectrum aggregation or a bandwidth aggregation. Unit carriers aggregated by a carrier aggregation is called a Component Carrier (CC). Each CC is defined by the bandwidth and the center frequency.

The carrier aggregation is introduced in order to support an increased throughput, prevent an increase of the expenses due to the introduction of a Radio Frequency (RF) device, and guarantee compatibility with the existing system. For example, if five CCs are allocated as the granularity of a carrier unit having a 5 MHz bandwidth, the bandwidth of a maximum of 20 MHz can be supported.

The carrier aggregation may be classified into an intra-band contiguous carrier aggregation, such as that shown in FIG. 2, an intra-band non-contiguous carrier aggregation, such as that shown in FIG. 3, and an inter-band carrier aggregation, such as that shown in FIG. 4.

Referring to FIG. 2, the intra-band contiguous carrier aggregation is formed within intra-band continuous CCs. For example, aggregated CCs, that is, a CC#1, a CC#2, a CC#3 to a CC #N are contiguous to each other.

Referring to FIG. 3, the intra-band non-contiguous carrier aggregation is formed between discontinuous CCs. For example, aggregated CCs, that is, a CC#1 and a CC#2 are spaced apart from each other by a specific frequency.

Referring to FIG. 4, the inter-band carrier aggregation is of a type in which, when a plurality of CCs exists, one or more of the CCs are aggregated on different frequency bands. For example, an aggregated CC, that is, CC #1 exists in a band #1, and an aggregated CC, that is, a CC #2 exists in a band #2.

The number of carriers aggregated between downlink and uplink may be different. The case where the number of DownLink Component Carriers (DL CCs) is identical with the number of UL CCs is called a symmetric aggregation, and a case where the number of DL CCs is different from the number of UL CCs is called an asymmetric aggregation.

CCs may have different sizes (i.e., bandwidths). For example, assuming that 5 CCs are used to configure a 70 MHz band, the configuration may have a form, such as 5 MHz CC (carrier #0)+20 MHz CC (carrier #1)+20 MHz CC (carrier #2)+20 MHz CC (carrier #3)+5 MHz CC (carrier #4).

A multiple carrier system hereinafter refers to a system supporting the carrier aggregation. In the multiple carrier system, the contiguous carrier aggregation or the non-contiguous carrier aggregation or both may be used. Furthermore, either the symmetric aggregation or the asymmetric aggregation may be used.

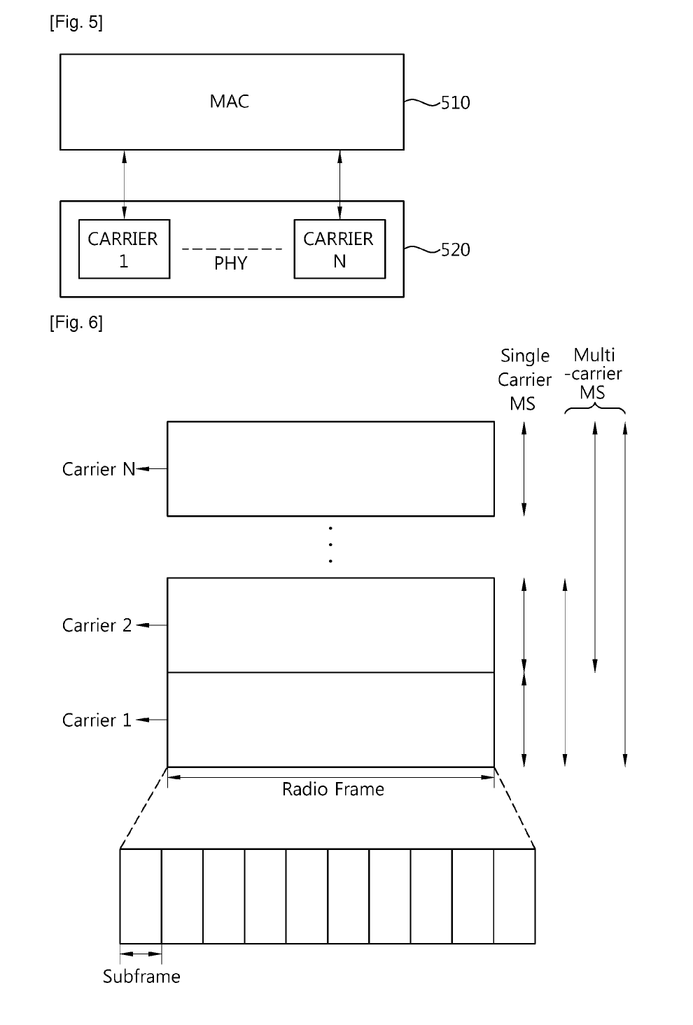

FIG. 5 shows an example of a protocol structure for supporting multiple carriers.

The number of aggregated carriers may be differently configured between downlink and uplink. A case where the number of DL CCs is identical with the number of UL CCs is called a symmetric aggregation, and a case where the number of DL CCs is different from the number of UL CCs is called an asymmetric aggregation.

FIG. 5 shows an example of a protocol structure for supporting multiple carriers.

Referring to FIG. 5, a common Medium Access Control (MAC) entity 510 manages a physical layer 520 using a plurality of carriers. An MAC management message transmitted through a specific carrier may be applied to other carriers. That is, the MAC management message is a message, including the specific carrier and being capable of controlling other carriers.

The physical layer 520 may be operated according to the TDD scheme or the FDD scheme or both.

There are several physical control channels used in the physical layer 520. A PDCCH (Physical Downlink Control CHannel) through which physical control information is transmitted informs an MS of the allocation of resources of a PCH (Paging CHannel) and a DL-SCH (downlink shared channel) and the allocation of HARQ (Hybrid Automatic Repeat Request) information pertinent to the DL-SCH. The PDCCH may carry an uplink grant, informing the MS of the allocation of resources for uplink transmission.

A PCFICH (Physical Control Format Indicator Channel) informs an MS of the number of OFDM symbols used in PDCCHs, and it is transmitted in each subframe.

A PHICH (Physical Hybrid ARQ Indicator Channel) carries HARQ ACK/NAK signals in response to uplink transmission.

A PUCCH (Physical Uplink Control CHannel) carries HARQ ACK/NAK signals for downlink transmission, a scheduling request, and uplink control information, such as a CQI. A PUSCH (Physical Uplink Shared Channel) carries an UL-SCH (uplink shared channel).

FIG. 6 shows an example of a frame structure for the operation of multiple carriers.

Referring to FIG. 6, a radio frame consists of 10 subframes. The subframe includes a plurality of OFDM symbols. Each CC may have its own control channel (e.g., PDCCH). The CCs may be contiguous to each other or may not be contiguous to each other. An MS may support one or more CCs according to its capability.

The CC may be divided into a Primary Component Carrier (hereinafter referred to as a ‘PCC’) and a Secondary Component Carrier (hereinafter referred to as an ‘SCC’) according to whether the CC has been activated. The PCC is always activated, and the SCC is activated or deactivated according to specific conditions.

The term ‘activation’ means that the transmission or reception of traffic data is being performed or is in a ready state. The term ‘deactivation’ means that the transmission or reception of traffic data is impossible, but measurement or the transmission or reception of minimum information is possible.

An MS may use only one PCC or may use the PCC and one or more SCCs. A BS may allocate a PCC or SCCs or both to an MS. The PCC is a carrier through which pieces of major control information are exchanged between a BS and an MS. The SCC is a carrier allocated at the request of an MS or according to an instruction made by a BS. The PCC may be used for an MS to enter a network or for the allocation of SCCs or both. The PCC is not fixed to a specific carrier, and a carrier configured as an SCC may be changed to a PCC.

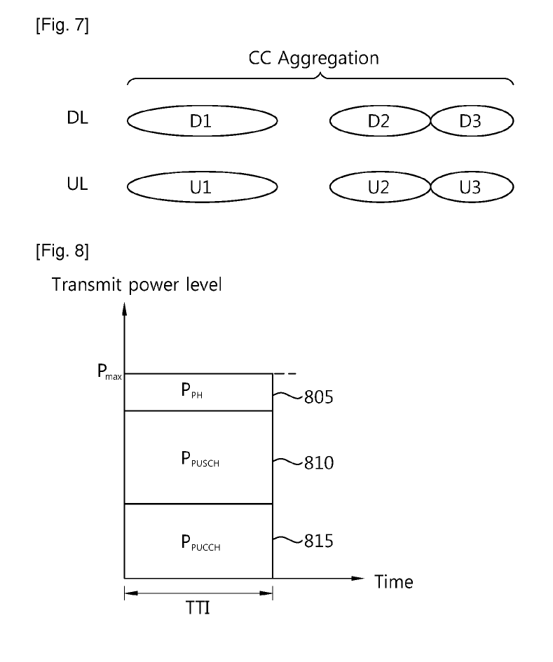

FIG. 7 shows a linkage between a DL CC and a UL CC in a multiple carrier system.

Referring to FIG. 7, in downlink, DL CCs (hereinafter referred to as ‘DL CCs’) D1, D2, and D2 are aggregated. In uplink, UL CCs (hereinafter referred to as ‘UL CCs’) U1, U2, and U3 are aggregated. Here, Di is an index of the DL CC, and Ui is an index of the UL CC (i=1, 2, 3). At least one DL CC is a PCC, and the remaining DL CCs are SCCs. Likewise, at least one UL CC is a PCC, and the remaining UL CCs are SCCs. For example, D1 and U1 may be PCCs, and D2, U2, D3, and U3 may be SCCs.

In an FDD system, a DL CC and an UL CC are linked to each other in a one to one way. The D1 is linked to the U1, the D2 is linked to the U2, and the D3 is linked to the U3. An MS performs the linkage between the DL CCs and the UL CCs through system information transmitted through a logical channel BCCH or an MS-dedicated RRC message transmitted through a DCCH. Each linkage may be set up in a cell-specific way or in an MS-specific way.

Examples of UL CCs linked to DL CCs are as follows.

1) UL CC through which an MS will transmit ACK/NACK information in response to data transmitted by a BS through a DL CC,

2) DL CC through which a BS will transmit ACK/NACK information in response to data transmitted by an MS through an UL CC

3) DL CC through which a BS will transmit a response when a BS receives a Random Access Preamble (RAP) transmitted by an MS, starting a random access procedure, through an UL CC,

4) UL CC to which uplink control information is applied when a BS transmits the uplink control information through a DL CC, and so on.

FIG. 7 illustrates only the example of the 1:1 linkage between the DL CC and the UL CC. It is, however, to be noted that a 1:n linkage or an n:1 linkage may also be established. Furthermore, the index of the CC is not identical with the sequence of the CC or the position of a frequency band of a relevant CC.

Power headroom (PH) is described below.

For example, it is assumed that an MS has a maximum transmission power of 10 W. It is also assumed that the MS is using power of 9 W by using the frequency band of 10 MHz. At this time, if the frequency band of 20 MHz is allocated to the MS, the MS requires power of 9 W×2=18 W. However, if 20 MHz is allocated to the MS because the MS has the maximum power of 10 W, the MS may not use the entire frequency band or a BS may not properly receive the signal of the MS because power is insufficient.

Meanwhile, it is common that data is suddenly generated according to its characteristic and the amount of data is not constant. If an MS has data to be suddenly transmitted to a BS, the BS may allocate a proper amount of radio resources to the MS if the BS has a PHR previously received from the MS before the generation of the data.

Furthermore, a periodic PHR method is used because power headroom is frequently changed. According to the periodic PHR method, an MS triggers the PHR when a periodic timer is completed and drives the periodic timer again when power headroom is reported.

In addition, the PHR is triggered even when a path loss (PL) estimate measured by an MS is changed by a specific value or higher. The path loss estimate is measured by an MS based on RSRP (Reference Symbol Received Power).

In the multiple component carrier system according to the present invention, the amount of power headroom may be different for each CC. Accordingly, there is proposed a method of measuring path loss for each CC. Furthermore, a required Modulation and Coding Scheme (MCS) is different for each component carrier. Accordingly, there is proposed a method of performing a PHR by taking the different MCS into consideration.

First, a power headroom P_{PH} is defined by a difference between maximum output to power Pₘₐₓ, configured in an MS, and power P_{estimated} estimated in relation to UL transmission as in Equation 1 and is expressed by dB.

P_{PH}=Pₘₐₓ−P_{estimated} [dBm] [Equation 1]

For example, it may be considered that P_{estimated} is equal to power P_{PUSCH} estimated in relation to PUCCH transmission. In this case, P_{PH} can be found by Equation 2.

P_{PH}=Pₘₐₓ−P_{PUSCH} [dBm] [Equation 2]

For another example, it may be considered that P_{estimated} is equal to the sum of power P_{PUSCH} estimated in relation to PUSCH transmission and P_{PUCCH} estimated in relation to PUCCH transmission. In this case, P_{PH} can be found by Equation 3.

P_{PH}=Pₘₐₓ−P_{PUCCH}−P_{PUSCH} [dBm] [Equation 3]

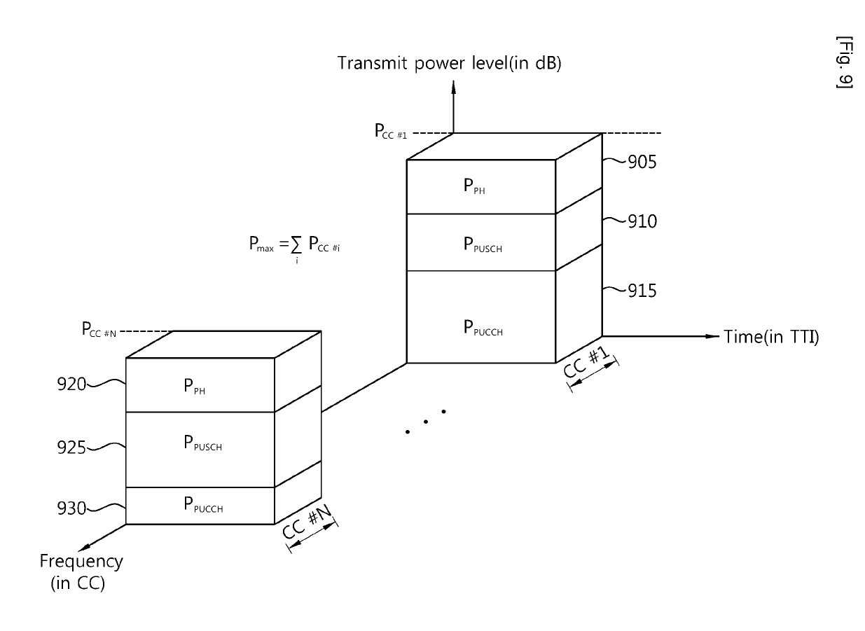

P_{PH} according to Equation 3 may be represented by a graph in the time-frequency axis, as shown in FIG. 8. This represents P_{PH} for one CC.

Referring to FIG. 8, the maximum output power Pₘₐₓ configured in an MS consists of P_{PH} 805, P_{PUSCH} 810, and P_{PUCCH} 815. That is, in the Pₘₐₓ, the remaining power headroom other than P_{PUSCH} 810 and P_{PUCCH} 815 is defined as P_{PH} 805. Each power is calculated in the unit of a Transmission Time Interval (TTI).

In the multiple component carrier system, power headroom may be defined for each of a plurality of CCs. This may be represented by a graph in the time-frequency axis, as shown in FIG. 9.

FIG. 9 shows an example in which in Equation 1, P_{estimated} is equal to the sum of power P_{PUSCH} estimated in relation to PUSCH transmission and power P_{PUCCH} estimated in relation to PUCCH transmission. Referring to FIG. 9, a maximum output power Pₘₐₓ configured in an MS is equal to the sum of maximum output powers PCC_{#1}, PCC_{#2} to PCC_{#N} for each of CC #1, CC #2 to CC #N.

Assuming that PCC_{#1}=PCC_{#2}=to=PCC_{#N}=PCC, P_{PH} 905 of the CC #1 is equal to PCCP_{PUSCH} 910-P_{PUCCH} 915, P_{PH} 920 of the CC #n is equal to PCC_P_{PUSCH} 925-P_{PUCCH} 930. A maximum output power level for each CC is constantly fixed, and P_{PH} has a different ratio for each CC.

For example, assuming that CC #1, CC #2, and CC #3 are allocated to an MS, a power headroom P_{PH1} regarding the CC #1 may be −8 dB, a power headroom P_{PH2} regarding the CC #2 may be −10 dB, and a power headroom P_{PH3} regarding the CC #3 may be 0 dB. Since the amount of the power headroom is different for each CC, the MS must inform a BS of a field (hereinafter referred to as a ‘power headroom value field’) indicating the amount of the power headroom for each CC. That is, the MS may send a plurality of power headroom value fields to the BS.

Path loss estimate for a specific UL CC is performed on the basis of a specific DL CC. It is hereafter assumed that a DL CC (that is, the reference of path loss estimate for a UL CC) is a reference DL CC. It is also assumed that information indicating the reference DL CC for each UL CC is a reference CC indicator. The information may be transmitted from a BS to an MS or may be previously agreed between an MS and a BS.

If the number of each of DL CCs and UL CCs is 1, there is only one reference DL CC (that is, the reference of path loss estimate for the UL CC. Accordingly, the path loss estimate has only to be performed with reference to the DL CC. If a plurality of CCs exists, however, path loss estimate for a specific UL CC must be determined regarding how the path loss estimate will be performed based on which DL CC.

For example, it is assumed that a DL CC#1, a DL CC#2, and a DL CC#3, and a UL CC#1, a UL CC#2, and a UL CC#3 are configured in a specific MS. Path loss for the UL CC#1 may be estimated on the basis of the DL CC#1, path loss for the UL CC#2 may be estimated on the basis of the DL CC#2, and path loss for the UL CC#3 may be estimated on the basis of the DL CC#3.

In the above example, although the DL CC having the same index as the UL CC has been decided as a reference DL CC, the reference DL CC is not necessarily limited thereto. Furthermore, the reference DL CC and the UL CC (i.e., the subject of path loss estimate) needs not to have the 1:1 relationship, but may have an n:1 relationship.

For example, assuming that four UL CCs are configured in an MS, a reference DL CC for a UL CC#1 and a UL CC#2 may be a DL CC#1, and a reference DL CC for a UL CC#3 and a UL CC#4 may be a DL CC#2.

If all the UL CCs and all the reference DL CCs have a 1:1 relationship, path loss is different for each CC. Accordingly, an MS must estimate path loss for each UL CC and perform each PHR procedure according to the estimated path loss. In this case, the number of power headroom value fields to be transmitted is equal to the number of all the CCs configured in the MS. For example, assuming that five CCs are configured in an MS, the MS finds power headroom for each of the CC#1, the CC#2, the CC#3, the CC#4, and the CC#5 and reports them to a BS.

However, if there are UL CCs and a reference DL CC having an n:1 relationship, plural pieces of path loss estimates which are the same or similar to each other may exist. In this case, it will be efficient to perform a PHR procedure for any one representative CC, instead of performing all the PHR procedures for all the CCs.

In this case, the number of power headroom value fields to be transmitted is smaller than the number of all CCs configured in an MS. For example, it is assumed that five CCs are configured in an MS, the reference DL CC of the UL CC#1, the UL CC#2, and the UL CC#3 is the DL CC#1, the reference DL CC of the UL CC#4 is the DL CC#4, and the reference DL CC of the UL CC#5 is the DL CC#5. In this case, the MS may find power headroom for any one of the UL CC#1, the UL CC#2, and the UL CC#3 and power headroom for the UL CC#4, and power headroom for the UL CC#5 and report them to a BS. That is, the amount of power headroom information to be reported is reduced.

It is hereinafter assumed that a mode in which an MS performs PHR procedures for all CCs is a first mode, and a mode in which an MS performs PHR procedures for only some CCs is a second mode.

Furthermore, a parameter to decide each of the modes is a mode decision parameter. The reference CC indicator is an example of the mode decision parameter.

According to the first and second modes, if there is at least one case where one DL CC is a reference DL CC for a plurality of UL CCs, an MS is operated in the second mode. Furthermore, an MCS (Modulation and Coding Scheme) may become a major parameter to decide the mode. This is because the amount of power headroom for each UL CC may be different according to the MCS.

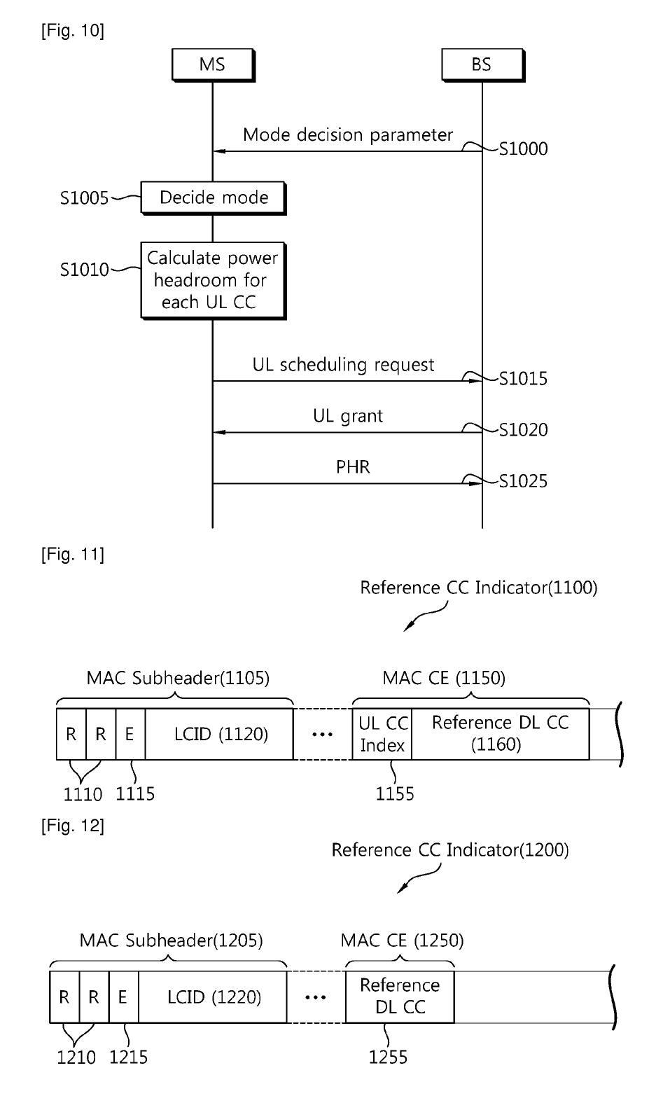

FIG. 10 is a flowchart illustrating a method of an MS performing a PHR procedure according to an example of the present invention.

Referring to FIG. 10, the MS obtains a mode decision parameter from a BS at step S1000. The mode decision parameter may include, for example, a reference CC indicator or an MCS or both.

The mode decision parameter may be control information which is generated in at least one of a physical layer, a MAC layer, and an RRC layer. Furthermore, the mode decision parameter may be previously known to the MS or may be known when it is received from the BS. Here, the received mode decision parameter is information that may be periodically received.

The MS decides a mode in which a PHR procedure will be performed on the basis of the mode decision parameter at step S1005. UL CCs (that is, the subject of a PHR) are determined according to the decided mode. For example, in the first mode according to the present invention, all UL CC(s) is the subject of a PHR. In the second mode, some of UL CC(s) are the subject of a PHR.

If the MS checks that a triggering condition for the PHR has been satisfied, the MS calculates power headroom for each of the UL CCs (that is, the subject of a PHR) according to the decided mode at step S1010.

Here, the triggering condition for the PHR includes any one of the following conditions.

1) In the case where an MS has UL resources for new transmission, when a change of a path loss is greater than a specific critical value and a prohibition PHR timer expires,

2) When a periodic PHR timer expires, and

3) When an upper layer sets or resets a PHR.

After the power headroom value(s) for the UL CCs configured to have the PHR procedure performed thereon is calculated, the MS may store the calculated power headroom value(s) and information or pieces of information, indicating a CC corresponding to the power headroom value(s), in a logical channel buffer.

The calculated power headroom value(s) and the information or the pieces of information, indicating a CC corresponding to the power headroom value(s), may be stored in a specific memory location, corresponding to one CC within the logical channel buffer, or may be stored the logical channel buffer(s) which are physically partitioned. In some embodiments, the calculated power headroom value(s) and the information or the pieces of information, indicating a CC corresponding to the power headroom value(s), may be stored in one logical channel buffer without logical or physical distinction for the CC.

Next, the MS requests uplink scheduling from the BS in relation to the CCs (i.e., the subject of a PHR) and transmits a Buffer State Report (BSR) at step S1015. The uplink scheduling request and the BSR may be transmitted at different points of time.

In response to the request, the BS transmits a UL grant to the MS at step S1020, and the MS performs the PHR procedure using resources allocated according to the UL grant at step S1025.

A technical characteristic according to each of the steps shown in FIG. 10 is described in detail.

The mode decision parameter is first described in detail.

1. A Case where the Mode Decision Parameter is a Reference CC Indicator

An example of the mode decision parameter is the reference CC indicator. As described above, the reference CC indicator is information indicating that path loss for each UL CC will be measured on the basis of which DL CC. That is, the reference CC indicator is information indicating a reference DL CC for each UL CC. If three UL CCs are configured in an MS, a BS must inform the MS of a reference DL CC for each of the three UL CCs.

The reference CC indicator may be transmitted in the form of the message of the MAC layer or the message of the RRC layer. If the reference CC indicator is the RRC message, information about which DL CC is the reference DL CC of which UL CC is included in UL CC configuration information when the CCs are configured and then transmitted.

In order to change the reference DL CC, changed UL CC configuration information may be included in an RRC reconfiguration message and then transmitted.

If reference CC information is applied to all MSs within a cell, the reference CC information may be included in radio resource-common information and transmitted. Furthermore, if the reference CC information is differently applied to each MS, the reference CC information may be included in radio resource-dedicated information and transmitted. The same principle applies to a case where the reference CC information is changed.

FIG. 11 is a block diagram showing a message structure of a reference CC indicator according to an example of the present invention. The example shown in FIG. 11 corresponds to a case where a reference CC indicator is a MAC layer message and one reference CC indicator includes only one reference DL CC information.

Referring to FIG. 11, the reference CC indicator 1100 includes a MAC subheader 1105 and a MAC Control Element (CE) 1150.

The MAC subheader 1105 may include two R fields 1110, an E field 1115, and an LCID field 1120. The R fields 1110 are redundant bits. The E field 1115 is an extension field indicating whether the additional LCID field 1120 exists in the subheader 1105.

If the E field 1115 is set to 1, it means that a set of another LCID field and anther E field follow the E field 1115. If the E field 1115 is set to 0, it means that MAC payload follows the E field 1115.

The LCID field 1120 is ID information indicating whether the relevant MAC CE 1150 is a reference CC indicator. Table 1 shows an example of the LCID field (1120) table.

TABLE 1

| INDEX | LCID VALUE |
|---|---|
| 00000 | CCCH |
| 00001-01010 | Identity of logical channel |
| 01011-11000 | Reserved |
| 11001 | Reference CC Indicator |
| 11010 | Power Headroom Report |
| 11011 | C-RNTI |
| 11100 | Truncated BSR |
| 11101 | Short BSR |
| 11110 | Long BSR |
| 11111 | Padding |

Referring to Table 1, the LCID field value 11001 indicates that the relevant MAC CE 1150 is a MAC CE for the transmission of a reference CC indicator.

The MAC CE 1150 includes a UL CC index field 1155 and a reference DL CC information field 1160. The UL CC index field 1155 indicates the index of a UL CC (i.e., the subject of a PHR), and the reference DL CC information field 1160 indicates a reference DL CC for a UL CC having the index.

For example, if a UL CC index is a UL CC#1 and reference DL CC information is DL CC#1, it can be seen that a reference DL CC for the UL CC#1 is the DL CC#1.

In the above example, the reference DL CC information is information unique to the reference DL CC. For example, the reference DL CC information may be a physical cell ID (PCI) and center frequency information. In this case, the reference DL CC information has the amount of information equal to the sum of the amount of information, indicating at least the physical cell ID, and the amount of information indicating the center frequency. The center frequency information is transmitted through a DL center frequency information field.

Another example of the reference DL CC information is an index of the reference DL CC. If an MS has already known indices regarding all DL CCs, the MS can know that a DL CC having a relevant index is a reference DL CC only when a BS informs the MS of only the DL CC index.

In a case where five DL CCs exist, if 3 bits are allocated in order to transfer the reference DL CC information, five DL CCs can be identified because the number of cases 2³=8 can be represented.

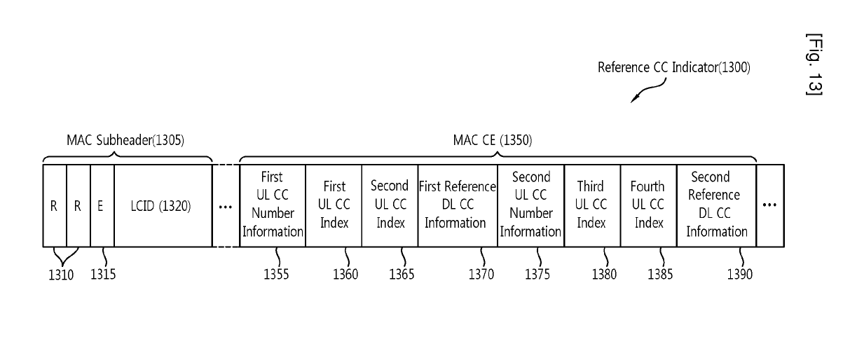

FIG. 12 is a block diagram showing a message structure of a reference CC indicator according to another example of the present invention. The example shown in FIG. 12 corresponds to a case where the reference CC indicator is a MAC layer message and one reference CC indicator includes only one reference DL CC information.

Referring to FIG. 12, the reference CC indicator 1200 includes a MAC subheader 1205 and a MAC CE 1250.

Even in FIG. 12, an example in which Table 1 shows the values of the LCID field 1220 may be taken into consideration. The MAC subheader 1205 is the same as the MAC subheader 1105 of FIG. 11. However, unlike in FIG. 11, the MAC CE 1250 does not include a UL CC index field, but includes only a reference DL CC information field 1255. The reference CC indicator, such as that shown in FIG. 12, may be applied to a case where only one reference DL CC for all UL CCs exists or a case where an additional UL CC index needs not to be transmitted or both.

FIG. 13 is a block diagram showing a message structure of a reference CC indicator according to yet another example of the present invention. In FIG. 13, it is assumed that the reference CC indicator is a MAC layer message and one reference CC indicator includes plural pieces of reference DL CC information.

Referring to FIG. 13, the reference CC indicator 1300 includes a MAC subheader 1305 and a MAC CE 1350.

The MAC subheader 1305 may include two R fields 1310, an E field 1315, and an LCID field 1320. Even in FIG. 13, an example in which Table 1 show the values of the LCID field 1320 may be taken into consideration.

The MAC CE 1350 includes a first UL CC number information field 1355, a first UL CC index field 1360, a second UL CC index field 1365, a first reference DL CC information field 1370, a second UL CC number information field 1375, a third UL CC index field 1380, a fourth UL CC index field 1385, and a second reference DL CC information field 1390.

The first UL CC number information field 1355 indicates the number of UL CCs corresponding to a first reference DL CC. That is, the first UL CC number information field 1355 indicates the number of UL CC index fields placed right after the first UL CC number information field 1355.

In the example of FIG. 13, the first UL CC number information field 1355 is 2. The first and the second UL CC index fields 1360 and 1365 indicate the indices of UL CCs corresponding to the first reference DL CC 1370.

Likewise, the second UL CC number information field 1375 indicates the number of UL CCs corresponding to a second reference DL CC.

In the example of FIG. 13, the second UL CC number information field 1375 is 2. The third and the fourth UL CC index fields 1380 and 1385 indicate the indices of UL CCs corresponding to the second reference DL CC 1390.

2. A Case where the Mode Decision Parameter is an MCS (Modulation and Coding Scheme)

An MS checks an MCS for UL transmission which is received through the PDCCH of a DL CC.

An error probability may differ according to a coding rate and a modulation order even when data is received at the same SINR. Accordingly, if CCs have different MCSs, path loss may be different, and thus power headroom for each UL CC is reported.

An MCS for UL transmission is included in a UL grant, which corresponds to a Downlink Control Information (DCI) format 0. The DCI format 0 is used to transmit information, such as that shown in Table 2.

TABLE 2
-Flag for format0/format1A differentiation -1bit, where value 0 indicates format 0 and value 1
indicates format 1A
-Frequency hopping flag -1 bit
-Resource block assignment and hopping resource allocation - ┌log₂ (N_{RB}^{UL} (N_{RB}^{UL} + 1) / 2)┐ bits

```
  -For PUSCH hopping:
  N_{UL}_{_{—}}ₕₒₚ MSB bits are used to obtain the value of ñ_{PRB}(i)
-(┌log₂ (N_{RB}^{UL}(N_{RB}^{UL} + 1) / 2)┐ − N_{UL}_{_{—}}ₕₒₚ) bit provide the resource allocation of the
first slot in the UL subframe
-For non-hopping PUSCH:
```

-┌log₂ (N_{RB}^{UL} (N_{RB}^{UL} + 1) / 2)┐ bits provide the resource allocation in the UL

subframe

-Modulation and coding scheme and redundancy version -5 bits
-New data indicator -1 bit
-TPC command for scheduled PUSCH -2 bits
-Cyclic Shift for DM RS -3 bits
-UL index - 2 bits (this field is present only for TDD operation with uplink-downlink
configuration 0)
- Downlink Assignment Index (DAI) -2 bits (this field is present only for TDD operation with
uplink-downlink configurations 1-6)
-CQI request -1 bit
-Carrier Index Field (CIF) - 3 bits(this field is present only for Carrier Aggregation)

Referring to Table 2, the MCS and the redundancy version are a total of 5 bits in size and inform an MCS for UL PUSCH transmission. The DCI of the format 0 includes a Carrier Index Field (hereinafter referred to as a ‘CIF’) indicating that the relevant DCI is about which carrier. For example, if five CCs exist, the carrier index field may be represented as in the following table.

TABLE 3

| CIF | CC |
|---|---|
| 000 | CC#1 |
| 001 | CC#2 |
| 010 | CC#3 |
| 011 | CC#4 |
| 100 | CC#5 |

Meanwhile, in the carrier aggregation, DCI may transmit not only information about the allocation of resources for carriers to which a PDCCH belongs, but also information about the allocation of resources for other carriers. This is called cross-carrier scheduling.

For example, it is assumed that an MS is in the cross-carrier scheduling activation state. The MS can know the MCS and the CIF by receiving an UL grant through a PDCCH. The MS recognizes the MCS as the MCS of a UL CC corresponding to a value of the CIF. For example, if the CIF value of an UL grant received through a DL CC#2 is a CC#4, an MCS within the UL grant is recognized as the fourth MCS of a UL CC. Even though UL CCs have the same reference DL CC, path loss may be different if the MCS level is different.

On the other hand, it is assumed that an MS is not in the cross-carrier scheduling activation state. In this case, the MS recognizes the MCS on an UL grant as the MCS of a UL CC linked to a DL CC through which the UL grant has been transmitted in a cell-specific or MS-specific way.

A method of deciding a mode of the PHR using the mode decision parameter is described below.

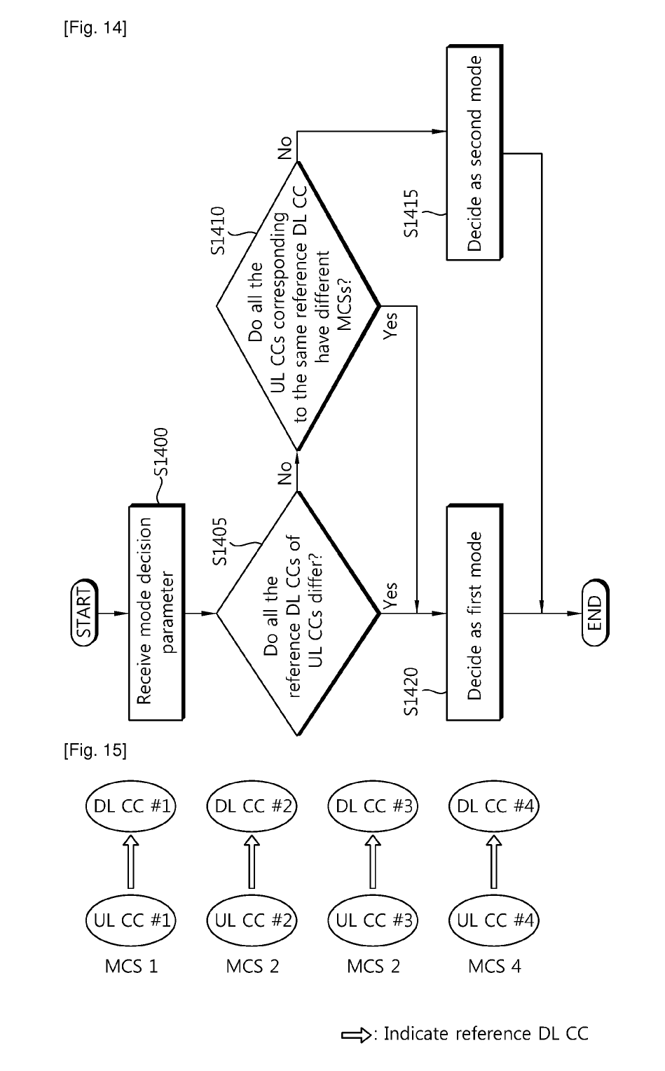

FIG. 14 is a flowchart illustrating a method of an MS deciding a mode according to an example of the present invention.

Referring to FIG. 14, an MS receives a mode decision parameter from a BS at step S1400. The mode decision parameter includes a reference CC indicator and an MCS. A method of receiving the reference CC indicator and the MCS has been described above.

The MS determines whether reference DL CCs corresponding to respective configured UL CCs are different from each other at step S1405. For example, if a UL CC#1 and a UL CC#2 are configured, but a reference DL CC for the UL CC#1 is a DL CC#1 and a reference DL CC for the UL CC#2 is a DL CC#2, the MS determines that all the reference DL CCs are different from each other.

Meanwhile, if a UL CC#1 and a UL CC#2 are configured, but a reference DL CC for the UL CC#1 and the UL CC#2 is a DL CC#1, the MS determines that all the reference DL CCs are not different from each other. In other words, the MS determines that one or more reference DL CCs overlap with each other.

If all reference DL CCs for respective UL CCs are different from each other, the MS decides the first mode as the mode of the PHR at step S1420. Here, what all the reference DL CCs are different from each other means that path losses may be different from each other and pieces of power headroom for the respective UL CCs may also be different from each other. Accordingly, the MS decides the first mode as the mode of the PHR and reports pieces of power headroom for all the UL CCs to the BS.

If, as a result of the determination at step S1405, all the reference DL CCs corresponding to the respective UL CCs are not different from each other, the MS determines whether all the MCSs of respective UL CCs corresponding to redundant reference DL CCs are different from each other at step S1410.

For example, if the MCSs of a UL CC#1 and a UL CC#2 corresponding to the same reference DL CC#1 are set to a level 2 and a level 4, the MS determines that the UL CC#1 and the UL CC#2 have different MCSs. On the other hand, if the MCSs of a UL CC#1 and a UL CC#2 corresponding to the same reference DL CC#1 are set to a level 2, the MS determines that all the MCSs are not different from each other.

If all the MCSs of the respective UL CCs corresponding to the reference DL CCs are not different from each other, the MS decides the second mode as the mode of the PHR at step S1415. The second mode corresponds to a case where at least two UL CCs have the same reference DL CC and at least two UL CCs have the same MCS.

In relation to the operation of the second mode, the MS may configure some UL CCs so that the PHR procedure is not performed on the UL CCs.

For example, if UL CCs, corresponding to the same reference DL CC and having the same MCS, satisfy any one of the following conditions, the MS performs the PHR procedure for the UL CCs. If any one of the following conditions is not satisfied, the MS may not perform the PHR procedure for the UL CCs. The conditions must be previously agreed between the MS and the BS.

UL CC having the lowest center frequency value

ULCC having the widest bandwidth

If, as a result of the determination at step S1410, all the MCSs of the respective UL CCs corresponding to the reference DL CCs are different from each other, the MS decides the first mode as the mode of the PHR at step S1420.

If the UL CCs have the different reference DL CCs, path losses may differ. Accordingly, the MS must perform the PHR procedure for each of the UL CCs. That is, the MS is operated in the first mode.

However, although UL CCs have the same reference DL CC, path losses may be different if MCSs differ. Accordingly, it is preferred that an MS perform the PHR procedure for each of UL CCs having different MCSs even though the UL CCs have the same reference DL CC.

Meanwhile, if the reference DL CC is the same and the MCS level is the same, there is a very low possibility that a path loss may be different. The MS can reduce overhead by reporting only one power headroom on the basis of one reference DL CC in relation to UL CCs.

FIG. 15 is an explanatory diagram illustrating a mode decision method according to an example of the present invention.

Referring to FIG. 15, four DL CCs and four UL CCs are configured in an MS. The example shown in FIG. 15 corresponds to a case where the reference DL CC and the MCS of each UL CC indicated by a reference CC indicator are the same as those shown in the following table.

TABLE 4

| UL CC INDEX | REFERENCE DL CC | MCS LEVEL |
|---|---|---|
| #1 | #1 | 1 |
| #2 | #2 | 2 |
| #3 | #3 | 3 |
| #4 | #4 | 4 |

Referring to Table, 4, in the case of FIG. 15, the four UL CCs have different reference DL CCs. Accordingly, the MS is operated in the first mode irrespective of MCS levels of the UL CCs. Accordingly, the MS reports pieces of power headroom for all the UL CCs to a BS.

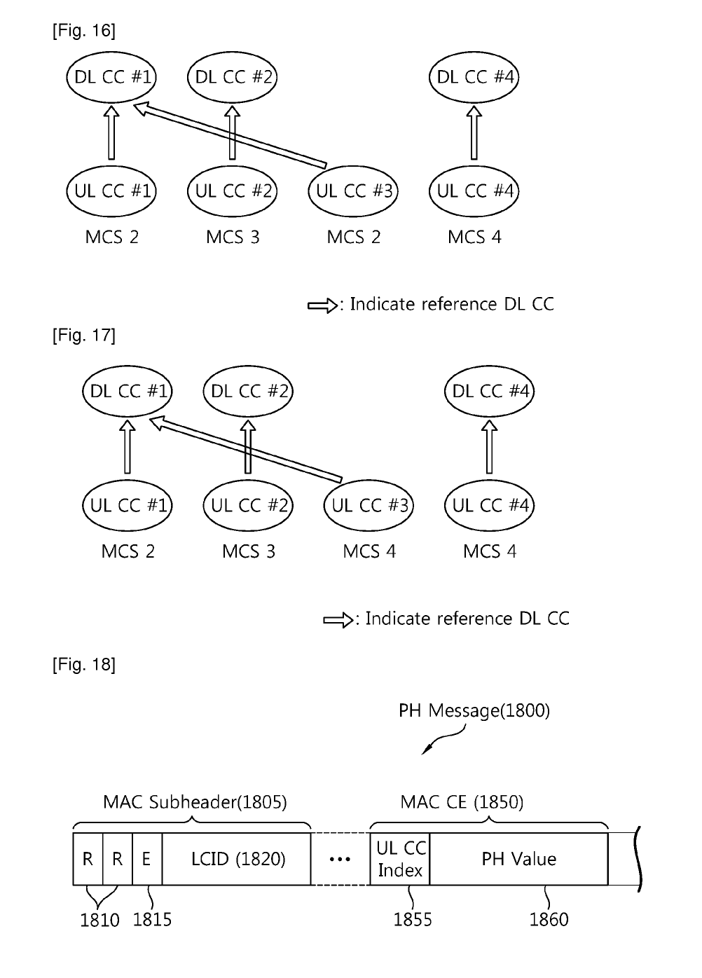

FIG. 16 is an explanatory diagram illustrating a mode decision method according to another example of the present invention.

Referring to FIG. 16, three DL CCs and four UL CCs are configured in an MS. In the case of FIG. 16, it is assumed that the reference DL CC and the MCS level of each UL CC indicated by a reference CC indicator are the same as those shown in the following table.

TABLE 5

| UL CC INDEX | REFERENCE DL CC | MCS LEVEL |
|---|---|---|
| #1 | #1 | 2 |
| #2 | #2 | 3 |
| #3 | #1 | 2 |
| #4 | #4 | 4 |

Referring to Table 5, in the case of FIG. 16, the UL CC #2 and the UL CC#4 have different reference DL CCs (i.e., DL CC#2 and DL CC#4). However, the UL CC#1 and the UL CC#3 have the same reference DL CC (i.e., DL CC#1).

That is, the MS performs the step S1410 in the flowchart of FIG. 14 because all the UL CCs do not have different reference DL CCs. That is, the MS determines whether MCS levels are different between UL CCs having the same reference DL CC.

Referring to Table 5, in the case of FIG. 16, the MCS levels of the UL CC#1 and the UL CC#3 are identically 2. It means that the MCS levels of all the UL CCs are not different from each other. Accordingly, the MS is operated in the second mode, and the MS reports pieces of power headroom for the UL CC#2 and the UL CC#4 having different reference DL CCs and reports only one of pieces of power headroom for the UL CC#1 and the UL CC#3 having the same reference DL CC and MCS level.

FIG. 17 is an explanatory diagram illustrating a mode decision method according to yet another example of the present invention.

Referring to FIG. 17, three DL CCs and four UL CCs are configured in an MS. The example shown in FIG. 17 corresponds to a case where the reference DL CC and the MCS level of each UL CC indicated by a reference CC indicator are the same as those shown in the following table.

TABLE 6

| UL CC INDEX | REFERENCE DL CC | MCS LEVEL |
|---|---|---|
| #1 | #1 | 2 |
| #2 | #2 | 3 |
| #3 | #1 | 4 |
| #4 | #4 | 4 |

Referring to Table 6, in the example of FIG. 17, the UL CC #2 and the UL CC#4 have different reference DL CCs (i.e., DL CC#2 and DL CC#4), but the UL CC#1 and the UL CC#3 have the same reference DL CC (i.e., DL CC#1). That is, the MS performs the step S1410 in the flowchart of FIG. 14 because all the UL CCs do not have different reference DL CCs.

That is, referring to Table 6, in the case of FIG. 17, the MS determines whether all the UL CCs having the same reference DL CC have different MCS levels. However, the UL CC#1 has an MCS level of 2 and the UL CC#3 has an MCS level of 4. Accordingly, the MS is operated in the first mode, and the MS reports pieces of power headroom for all the UL CCs to a BS.

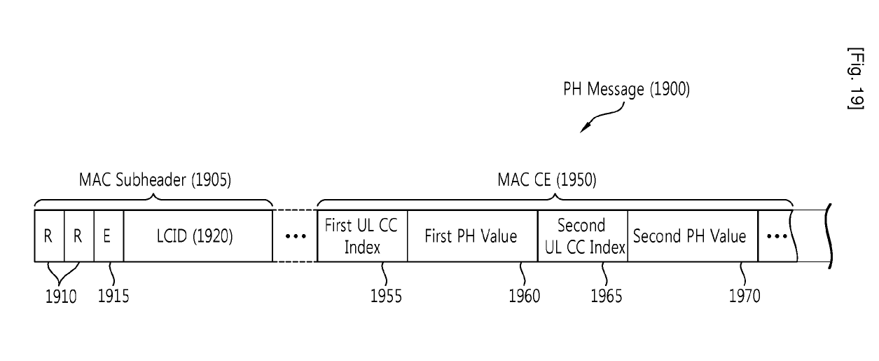

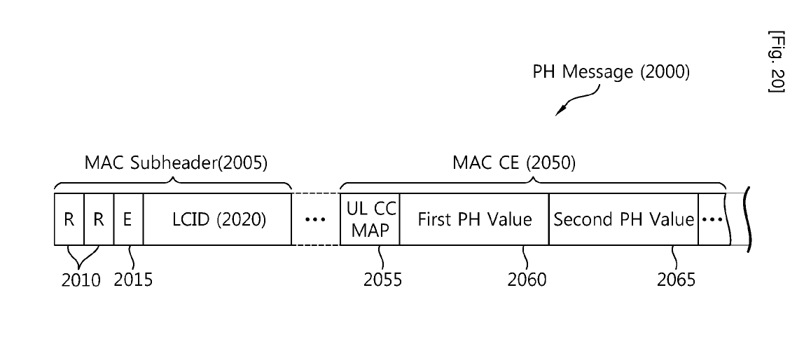

FIG. 18 is a diagram showing a structure of a PH message for transmitting a power headroom value according to an example of the present invention. The example shown in FIG. 18 corresponds to a case where a power headroom (PH) message transmitting a power headroom value is a MAC layer message and one PH message includes only a power headroom value for one UL CC.

Referring to FIG. 18, the PH message 1800 includes a MAC subheader 1805 and a MAC CE 1850.

The MAC subheader 1805 includes two R field s1810, an E field 1815, and an LCID field 1820. An example of the LCID field (1820) table is shown in the following table.

TABLE 7

| INDEX | LCID VALUE |
|---|---|
| 00000 | CCCH |
| 00001-01010 | Identity of logical channel |
| 01011-11000 | Reserved |
| 11001 | Reference CC Indicator |
| 11010 | Power Headroom Report |
| 11011 | C-RNTI |
| 11100 | Truncated BSR |
| 11101 | Short BSR |
| 11110 | Long BSR |
| 11111 | Padding |

Table 7 is identical with Table 1. Referring to Table 7, when the LCID field 1820 has a value of 11010, it means that a relevant MAC CE is for a PHR.

The MAC CE 1850 includes a UL CC index field 1855 and a power headroom value 1860. The UL CC index field 1855 indicates that the next power headroom value field 1860 is about which UL CC. An example of the UL CC index field (1855) table is shown in the following table.

TABLE 8

| UL CC INDEX | CC |
|---|---|
| 000 | CC#1 |
| 001 | CC#2 |
| 010 | CC#3 |
| 011 | CC#4 |
| 100 | CC#5 |

Meanwhile, an example of the power headroom value field (1860) table is shown in the following table.

TABLE 9

| | | MEASURED |
|---|---|---|
| PH | | QUANTITY |
| FIELD | PH LEVEL | VALUE (dB) |
| 0 | Power Headroom_0 | −23 ≦ P_{PH} ≦ −22 |
| 1 | Power Headroom_1 | −22 ≦ P_{PH} ≦ −21 |
| 2 | Power Headroom_2 | −21 ≦ P_{PH} ≦ −20 |
| 3 | Power Headroom_3 | −20 ≦ P_{PH} ≦ −19 |
| . . . | . . . | . . . |
| 60 | Power Headroom_60 | 37 ≦ P_{PH} ≦ 38 |
| 61 | Power Headroom_61 | 38 ≦ P_{PH} ≦ 39 |
| 62 | Power Headroom_62 | 39 ≦ P_{PH} ≦ 40 |
| 63 | Power Headroom_63 | P_{PH} ≧ 40 |

Referring to Table 9, the value of power headroom belongs to a range of −23 dB to +40 dB. When the power headroom value field 1860 is 6 bits, 2⁶=64 cases of indices can be represented. Accordingly, the power headroom values are classified into a total of 64 levels.

For example, when the power headroom value field is 0 (i.e., 000000 when represented by 6 bits), it means that the value of power headroom for a UL CC is −23≦P_{PH}≦−22 dB.

FIG. 19 is a diagram showing a structure of a PH message for transmitting a power headroom value according to another example of the present invention. The example of FIG. 19 corresponds to a case where the PH message transmitting the power headroom value is a MAC layer message and one PH message includes only a power headroom value for a plurality of UL CCs.

Referring to FIG. 19, the PH message 1900 includes a MAC subheader 1905 and a MAC CE 1950.

The MAC subheader 1905 includes two R fields 1910, an E field 1915, and an LCID field 1920. An example of the LCID field (1920) table is the same as that shown in Table 7.

The MAC CE 1950 includes a first UL CC index field 1955, a first power headroom value field 1960, a second UL CC index field 1965, a second power headroom value field 1970, and so on. That is, the MAC CE 1950 has a repetition pattern in which a set of one UL index field and one power headroom value field are bundled. An n^{th} UL CC index field indicates that an n^{th} power headroom value field right after the n^{th} UC CC index field is about which UL CC. An example of each UL CC index field table is the same as that shown in Table 8, and an example of each power headroom value field table is the same as that shown in Table 9.

Here, the second power headroom value field 1970 may have a differential value between a second power headroom value and a first power headroom value not the second power headroom value.

For example, it is assumed that a first power headroom value for a UL CC#1 is 7 dB and a second power headroom value for a UL CC#2 is 9 dB. In this case, the first power headroom value field 1960 may indicate 7 dB, and the second power headroom value field 1970 may indicate 2 dB. That is, a power headroom value for a UL CC having a specific index may be represented by a differential value between power headroom values for UL CCs having previous indices. The second power headroom value field 1970 does not need to represent all ranges of values in the second power headroom value, but has only to represent only a difference from the first power headroom value. Accordingly, the number of bits consumed to represent power headroom values can be reduced.

In this case, the first power headroom value field (1960) table is the same as that shown in Table 9, and the second power headroom value field (1970) table may be separately written so that differential values can be represented. For example, if a differential value is set to a range of ±7 dB, the second power headroom value field 1970 may be represented by 4 bits. In this case, an example of the power headroom value field is the same as that shown in Table 10.

TABLE 10

| SECOND POWER | DIFFERENTIAL |
|---|---|
| HEADROOM VALUE FIELD | VALUE |
| 0000 | −7 dB |
| 0001 | −6 dB |
| . . . | |
| 0111 | 0 dB |
| . . . | . . . |
| 1101 | 5 dB |
| 1110 | 6 dB |
| 1111 | 7 dB |

In Table 10, when the second power headroom value field 1970 is 0111, it means that the second power headroom value is the same as the first power headroom value. When the second power headroom value field 1970 is 1101, it means that the second power headroom value is greater than the first power headroom value by 5 dB.

FIG. 20 is a diagram showing a structure of a PH message for transmitting a power headroom value according to yet another example of the present invention. The example of FIG. 20 corresponds to a case where the PH message transmitting the power headroom value is a MAC layer message and one PH message includes the power headroom value for a plurality of UL CCs.

Referring to FIG. 20, the PH message 2000 includes a MAC subheader 2005 and a MAC CE 2050.

The MAC subheader 2005 includes two R fields 2010, an E field 2015, and an LCID field 2020. An example of the LCID field (2020) table is the same as that shown in FIG. 7.

The MAC CE 2050 includes a UL CC MAP field 2055, a first power headroom value field 2060, a second power headroom value field 2065, etc. The second power headroom value field 2065 may have a second actual power headroom value or may have a differential value between the second power headroom value and the first power headroom value. An example of the power headroom value field is the same as that shown in Table 10.

The UL CC MAP field 2055 is a field in which an UL CC index is represented in the form of a bitmap. The UL CC MAP field 2055 may have the same number of bits as the number of UL CCs configured in an MS. For example, if five UL CCs are configured in the MS, the UL CC MAP field 2055 may have 5 bits.

In the UL CC MAP field 2055, if a bit value corresponding to a specific UL CC is 0, the MAC CE 2050 does not include a power headroom value field for a UL CCL having a relevant index. However, in the UL CC MAP field 2055, if a bit value corresponding to a specific UL CC is 1, the MAC CE 2050 includes a power headroom value field for a UL CC having a relevant index. That is, in the UL CC MAP field represented in the form of a bitmap, 1 and 0 indicate whether relevant PHRs exist (i.e., ON and OFF).

For example, it is assumed that the first bit to the last bit of the UL CC MAP field 2055 are mapped to a UL CC#1, a UL CC#2 to a UL CC#5, respectively. If the UL CC MAP field 2055 has a value of 01010, the first, the third, and the fifth UL CCs (i.e., UL CC#1, UL CC#3, and UL CC#5) are set to 0. Accordingly, power headroom value fields for the first, the third, and the fifth UL CCs do not exist. That is, PHR procedures for the first, the third, and the fifth UL CCs are not performed. On the other hand, in the value 01010 of the UL CC MAP field 2055, the second and the fourth UL CCs (i.e., UL CC#2 and UL CC#4) are set to 1. Accordingly, power headroom value fields for the second and the fourth UL CCs exist, and PHR procedures for the second and the fourth UL CCs are performed.

The UL CC MAP field 2055 needs not to be necessarily the same as the number of UL CCs configured. For example, if a CC on which a PHR procedure has to be always performed as in a PCC is defined, only the remaining CCs (i.e., SCCs) other than the PCC may constitute a UL CC MAP. In this case, if the number of UL CCs configured is 5, the UL CC MAP field 2055 has 4 bits in size.

For example, a case where a PCC has a CC index of 3 and the UL CC MAP field 2055 is represented by ‘1101’ is taken into consideration. In this case, the UL CC MAP field 2055 is configured in relation to the remaining UL CCs (i.e., UL SCCs) other than the PCC. Since the UL CC MAP field 2055 has ‘1101’, a UL CC#1 has a value of 1, a UL CC#2 has a value of 1, a UL CC#4 has a value of 0, and a UL CC#5 has a value of 1. Accordingly, the PHR procedure is performed on the UL CC#1, the UL CC#2, and the UL CC#5 other than the PCC (i.e., the UL CC#3) on which the PHR procedure is always performed, but the PHR procedure is not performed on the UL CC#4. As described above, in the present embodiment, the UL CC MAP field 2055 may be a field indicating whether power headroom for a UL SCC will be reported (i.e., indicating whether a power headroom value field exists).

Furthermore, the value of a UL CC MAP field may be configured using fields having a less number than fields allocated to indicate CCs. For example, if the number of bits allocated to a UL CC MAP field is 8 bits and an actually configured UL CC MAP field value is represented by ‘111 of 3 bits, an actual field may be represented by ‘00000111’.

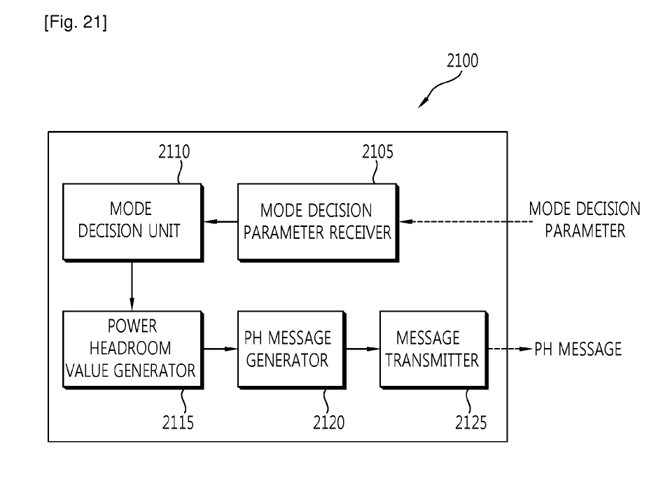

FIG. 21 is a block diagram showing a power headroom transmitter according to an example of the present invention.

Referring to FIG. 21, the power headroom transmitter 2100 includes a mode decision parameter receiver 2105, a mode decision unit 2110, a power headroom value generator 2115, a PH message generator 2120, and a message transmitter 2125. The power headroom transmitter 2100 may be a part of an MS.

The mode decision parameter receiver 2105 receives a mode decision parameter from a BS. The mode decision parameter, as described above, includes a reference CC indicator and an MCS. Furthermore, the mode decision parameter receiver 2105 receives an UL grant necessary to transmit a PH message from the BS.

The mode decision unit 2110 decides any one of the first mode and the second mode on the basis of the mode decision parameter. The first mode and the second mode have been described in detail.

The power headroom value generator 2115 generates a power headroom value for each of specific UL CCs according to the first mode or the second mode.

The PH message generator 2120 generates the PH message for transmitting each of the generated power headroom values. The power headroom value included in the PH message may be an actual power headroom value for the UL CC which has been selected so that a PHR procedure is performed on the UL CC or may be a differential value between the power headroom values of the respective UL CCs. The structure of the PH message is the same as that shown in FIGS. 18 to 20.

The message transmitter 2125 transmits a scheduling request message, requesting UL resources for transmitting the PH message, to the BS and transmits the generated PH message to the BS using the UL resources according to an UL grant.

A CC may be defined as a concept, including a DL CC or both a DL CC and a UL CC and may also be defined as a cell. In other words, a cell may be defined as only DL frequency resources (e.g., component carriers) to which a radio signal recognizable by an MS in a certain area can arrive. Alternatively, the cell may be defined as a pair of UL frequency resources that an MS, capable of receiving a signal from a BS, can transmit the UL frequency resources to the BS through DL frequency resources and a DL frequency.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not limited by the embodiments, and the scope of the present invention should be interpreted based on the following appended claims. Accordingly, the present invention should be construed to cover all modifications or variations induced from the meaning and scope of the to appended claims and their equivalents.

1. A method of a mobile station transmitting power headroom information in a multiple component carrier system, the method comprising:
receiving a mode decision parameter for deciding a mode of a Power Headroom Report (hereinafter referred to as a ‘PHR’) for UpLink Component Carriers (hereinafter referred to as ‘UL CCs’) configured in the mobile station, from a base station;
deciding the mode of the PHR based on the mode decision parameter; and
transmitting the power headroom information to the base station based on the decided mode of the PHR,
wherein the mode of the PHR includes a first mode in which power headroom information about all the configured UL CCs is transmitted and a second mode in which power headroom information about some of the configured UL CCs is transmitted.

2. The method claim 1, wherein the mode decision parameter comprises a reference CC indicator which is information about a reference DownLink Component Carriers (hereinafter referred to as a ‘DL CC’) for estimating a path loss for each of the configured UL CCs.

3. The method claim 2, wherein the reference CC indicator is a Medium Access Control (hereinafter referred to as a ‘MAC’) message generated in a MAC layer.

4. The method claim 3, wherein the MAC message comprises a MAC subheader and a MAC Control Element (hereinafter referred to as a ‘MAC CE’).

5. The method claim 4, wherein:
the MAC CE comprises a field indicative of an index of the UL CC and a field indicative of information about the reference DL CC for the UL CCs, and
the MAC subheader comprises an identification (ID) field indicating that the MAC CE is for the PHR.

6. The method claim 4, wherein the MAC CE comprises a field indicating information about the reference DL CC for the configured UL CCs.

7. The method claim 4, wherein the MAC CE comprises:
information about the number of UL CCs,
indices of the UL CCs corresponding to the number, and
information about a reference DL CC regarding the UL CCs corresponding to the number.

8. The method claim 1, wherein the reference CC indicator is a Radio Resource Control (RRC) message generated in an RRC layer.

9. The method claim 1, wherein the mode decision parameter comprises a Modulation and Coding Scheme (hereinafter referred to as an ‘MCS’) for a Physical Uplink Shared Channel (hereinafter referred to as a ‘PUSCH’) for each of the configured UL CCs.

10. The method claim 1, wherein the mode decision parameter comprises a reference CC indicator which is information about a reference DownLink (DL) CC for estimating a path loss for each of the configured UL CCs or an Modulation and Coding Scheme (MCS) for a PUSCH for each of the configured UL CCs or both.

11. The method claim 10, wherein deciding the mode of the PHR comprises deciding the mode of the PHR as the first mode when all the reference DL CCs for the configured UL CCs are different from each other.

12. The method claim 10, wherein deciding the mode of the PHR comprises deciding the mode of the PHR as the first mode when some UL CCs corresponding to an identical reference DL CC, from among the configured UL CCs, have different MCSs.

13. The method claim 10, wherein deciding the mode of the PHR comprises deciding the mode of the PHR as the second mode when some UL CCs corresponding to an identical reference DL CC, from among the configured UL CCs, have an identical MCS.

14. The method claim 1, wherein the power headroom information is a Medium Access Control (MAC) message.

15. The method claim 14, wherein the MAC message comprises an index of a UL CC field which is a subject of the PHR according to the mode of the PHR.

16. The method claim 15, wherein the MAC message further comprises a UL CC MAP indicating whether a PHR regarding the configured UL CC exists.

17. An apparatus for transmitting power headroom information in a multiple component carrier system, the apparatus comprising:
a mode decision parameter receiver for receiving a mode decision parameter for deciding a mode of a Power Headroom Report (PHR) for configured UpLink Component Carriers (UL CCs) from a base station;
a mode decision unit for deciding the mode of the PHR as a first mode or a second mode based on the mode decision parameter;
a power headroom value generator for generating power headroom values for all the configured UL CCs when the mode of the PHR is the first mode and for generating power headroom values for some of the configured UL CCs when the mode of the PHR is the second mode;
a power headroom message generator for generating a power headroom message for transmitting the generated power headroom values; and
a power headroom message transmitter for transmitting the generated power headroom message.

18. A method of a mobile station performing a power headroom report, comprising:
determining whether any one of a case in which path loss variations is higher than a specific threshold and a prohibit power headroom report timer expires, a case in which a periodic power headroom report timer expires, and a case in which the power headroom report is configured or re-configured by an upper layer is occurred in a case in which a mobile station has uplink resources for new transmit; and
triggering the power headroom report when any one of the cases is occurred,
wherein the power headroom report comprises a field indicating whether there is a power headroom report for each uplink subcomponent carrier.
